(19) United States
(12) Patent Application Publication
(10) Pub. No.: US 2012/0279831 A1
(43) Pub. Date: Nov. 8, 2012

(54) Drive Transmission Method in a Longwall Shearer Loader

(75) Inventors: Ryszard Bednarz, Katowice (PL); Pawel Gwiazdzinski, Zernica (PL); Lukasz Gonsior, Marklowice (PL); Mateusz Golabek, Dabrowa Gornicza (PL)

(73) Assignees: FAMUR INSTITUTE SP. Z O.O., Katowice (PL); FAMUR SPOLKA AKCYJNA, Katowice (PL)

(21) Appl. No.: 13/509,251

(22) PCT Filed: Nov. 2, 2010
(86) PCT No.: PCT/PL10/00108

§ 371 Date: Jul. 30, 2012

(30) Foreign Application Priority Data
Nov. 10, 2009 (PL) P389530

(51) Int. Cl. B65G 23/24

(52) U.S. Cl. 198/832

(57) ABSTRACT

The drive transmission method used in the case of a longwall shearer loader is characterised by the fact that in the shearer body (1), from the side wall side, in the part located outside of the chain conveyor (2), there is an motor (3) and a transmission unit (4) propelling a drive shaft (6) located in the part of the shearer body (1) located above the armoured face conveyor (2). The shaft transmits the power to the drive wheel (10) installed in the shearer body (1) from the caving side, outside of the chute of the chain conveyor (2), and moving along the ladder (11).

The subject of the invention is a drive transmission method in a longwall shearer loader.

A coal shearer equipped with a feed haulage gear without wrapping connectors has already been described in the Polish description of the patent No. 170568. Such a shearer is equipped with a drive gear and an idle wheel toothed with it. Both are located in a specially shaped part of the haulage gear body. The idle wheel cooperates with a ladder and is guided along it by guides. The idle wheel is mounted in a detachable housing, which is attached to the body of the haulage gear. The housing's shape resembles a rectangle, whose upper corner located above the idle wheel has been truncated. The bottom edge of the housing protrudes outside of the lower part of the haulage gear body.

A drive transmission unit, particularly the one used in cutter-loaders, has already been described in the Polish description of the patent No. 172361. The unit is composed of a drive gear and an identical idle wheel toothed with it, which at the same time functions as a fast wheel cooperating with an inflexible pin connector or with a chain connector. The idle wheel is fixed to the shearer frame, which may be disconnected from the haulage gear. The module drive gear mounted on the drive shaft of the haulage gear cooperates with the module idle wheel mounted on the axle, where the fast wheel is mounted, too. The module idle wheel is fixed in relation to the fast wheel and the axle is fixed in the holder.

A haulage gear has already been described in the Polish description of the patent No. 180563. The mechanism is composed of a gear wheel mounted on a drive shaft and a module idle wheel mounted on the axle, which is fixed in a holder. The holder (detachable) is connected with the haulage gear body and a frame of the shearer slide and is equipped with a cover. The idle wheel is located between the gear wheel and the drive gear unit and is mounted on the axle, which is fixed in the hubs equipped with eccentric bushes. One hub along with its eccentric bush is fixed in the housing of the holder. The other hub along with its eccentric bush is fixed in the cover of the holder.

A drive transmission unit used in cutter-loaders has also been described in the Polish description of the patent No. 188549. The unit, also referred to as the housing fixed to the front panel of the haulage gear and the shearer frame, is composed of a drive gear toothed with a fast gear wheel mounted on the axle located in the housing and a shoe. The axle of the fast wheel is mounted in the inlets located in the openings. One inlet is mounted in a recess in the plate and the other one in the housing's cover.

The drive transmission method used in the case of a longwall shearer loader, in line with the invention, is characterised by the fact that in the shearer body, from the side wall side, in the part located outside of the chain conveyor, there is an motor and a transmission unit propelling the drive shaft located in the part of the shearer body situated above the armoured face chain conveyor (armoured face conveyor). The shaft transmits the power to the drive wheel installed in the shearer body from the caving side outside of the line pan (chute) of the armoured face conveyor and moving along the ladder.

On the one side the drive shaft is fixed in the coupling of the transmission unit and on the other side—in the coupling of the idle wheel or directly in the coupling of the drive wheel.

The drive transmission method for a longwall shearer loader based on the invention enables constructing a uniform shearer body, which translates into improved structure rigidity and reduces shearer's height above the conveyor while maintaining the maximum “a” clearance. The solution proposed in the invention significantly improves maintenance conditions; especially in the case it is necessary to replace a drive wheel.

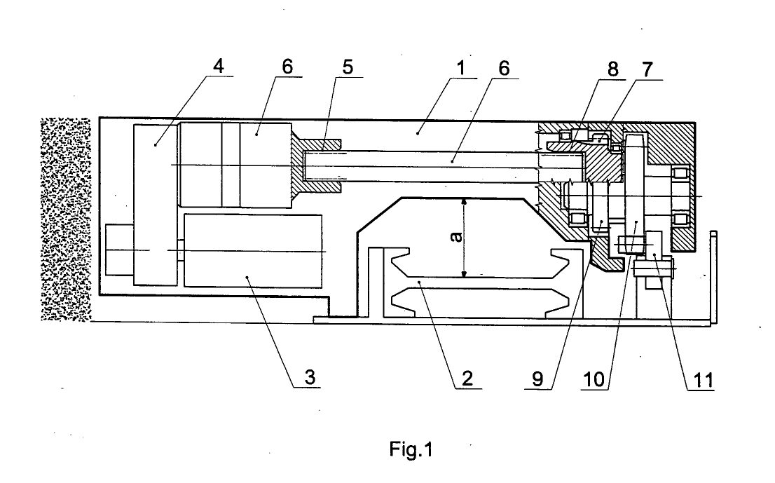

An example of the subject of the invention has been presented in the drawing, where FIG. 1 indicates a schematic drive transmission method in a longwall shearer loader.

The motor 3 along with the transmission unit 4, propelling the drive shaft 6 located in the part of the shearer body (1) located above the chain conveyor 2, is installed in the body of the shearer 1 from the side wall side in the part outside of the chain conveyor 2. The shaft transmits the power to the drive wheel 10 installed in the shearer body (1) from the caving side outside of the line pan of the armoured face conveyor 2 and moving along the ladder 11.

On the one side the drive shaft 6 is fixed in the coupling 5 of the transmission unit 4 and on the other side in the coupling 8 of the idle wheel 7 or directly in the coupling of the drive wheel 10.

1. The drive transmission method used in the case of a longwall shearer loader equipped with a transmission unit propelling a drive wheel (sprocket wheel) cooperating with a ladder characterised by the fact that in the shearer body (1), from the side wall side, in the part located outside of the armoured face conveyor (chain conveyor) (2), there is an motor (3) and a transmission unit (4) propelling the drive shaft (6) located in the part of the shearer body (1) situated above the armoured face conveyor (2), which transmits the power to the drive wheel (sprocket wheel) (10) installed in the shearer body (1) from the caving side, outside of the line pan (chut) of the chain conveyor (2), and moving along the ladder (11).

2. The drive transmission method used in the case of a longwall shearer loader described in the claim No. 1 characterised by the fact that the drive shaft (6) is fixed on the one side in the coupling (5) of the transmission unit (4) and on the other side in the coupling (8) of the idle wheel (7) or directly in the coupling of the drive wheel (10).
